(19) United States
(12) Patent Application Publication
(10) Pub. No.: US 2026/0336831 A1
(43) Pub. Date: Oct. 29, 2026

(54) DEFECT-BASED MATERIAL TO CONTROL SOLAR ABSORPTIVITY OF A SURFACE

(71) Applicant: Blue Origin Manufacturing, LLC, Huntsville, AL (US)

(72) Inventors: Arash Ghabchi, Bothell, WA (US); Benjamin I. Furst, Tujunga, CA (US); Benjamin Schneck, Bellevue, WA (US); Emmanuel John Grillos, II, Kent, WA (US)

(21) Appl. No.: 19/192,302

(22) Filed: Apr. 28, 2025

(51) Int. Cl. B64G 1/22; C23C 4/10; C23C 4/123

(52) U.S. Cl. CPC B64G 1/226; C23C 4/10; C23C 4/123

(57) ABSTRACT

Systems and methods for at least partially controlling heat absorption and emission by a spacecraft are presented. Generally, a spacecraft may absorb heat from solar radiation and may emit spacecraft-generated heat in the form of blackbody radiation. The skin or outer layers of the spacecraft, along with specially designed thermal radiators, may determine the thermal balance between the net heating and cooling of the spacecraft. A radiating surface of a spacecraft, such as a thermal radiator, may include a composite material system comprising a substrate and a thermal spray coating deposited on the substrate. The thermal spray coating may include a matrix having an emissivity optimized for IR radiation resulting from heat leaving the spacecraft. The matrix may include voids that have a characteristic length that is optimized to scatter and reflect visible light from the Sun away from the thermal spray coating.

### BACKGROUND

The exterior of a spacecraft is generally subjected to extreme conditions in space, including intense solar radiation and the cold vacuum of space. The paint or coating on the spacecraft may play a crucial role in managing these conditions. Such surfaces may be designed to reflect the majority of the incident solar rays, thereby reducing the amount of heat absorbed by the spacecraft.

In addition to reflecting solar radiation, such surfaces may also aid in the emission of heat generated inside the spacecraft. The systems and astronauts inside the spacecraft generate heat, and this heat needs to be dissipated to prevent overheating. Exterior surfaces of a spacecraft are thus generally relied upon to radiate this heat away into space, contributing to the thermal control of the spacecraft. Thermal control remains a significant factor in design considerations, and continuous efforts are being made to seek further improvements.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is schematic diagram of a composite material system that includes a heat radiator of a spacecraft, according to some embodiments.

FIG. 2 is a schematic view of a thermal spray coating, according to some embodiments.

FIG. 3 illustrates a portion of the solar spectrum in space, according to some embodiments.

FIG. 4 illustrates a portion of the blackbody spectrum for a heat radiator at an example temperature of about 350K, according to some embodiments.

FIG. 5 is schematic diagram of a thermal spray applicator depositing a thermal spray coating on a substrate, according to some embodiments.

FIG. 6 is a flow diagram of a process for operating a thermal spray applicator, according to some embodiments.

### DETAILED DESCRIPTION

This disclosure describes systems and methods for at least partially controlling heat absorption and emission by a spacecraft. Generally, a spacecraft may absorb heat from solar radiation and may emit spacecraft-generated heat (and absorbed solar radiation) in the form of blackbody radiation. The skin or outer layers of the spacecraft, along with specially designed thermal radiators, may determine the thermal balance between the net heating and cooling of the spacecraft. For example, internal operations and systems of the spacecraft generally produce heat and the spacecraft's exposure to solar radiation may add to this heat. Accordingly, in view of the extremely cold vacuum of space, efforts are made to thermally balance these factors.

In embodiments described herein, a radiating surface of a spacecraft, such as a thermal radiator, may include a composite material system comprising a substrate and a thermal spray coating deposited on the substrate. The thermal spray coating may include a primary phase matrix material that has intrinsic material optical properties, such as those of some selective surface ceramics, for example, that allow it to both reflect over the solar spectrum (e.g., about 200 to 2500 nm) and emit (or inversely absorb) in the infrared (IR) range. Since the wavelength of solar radiation doesn't extend up to the thermal IR wavelength region, the absorptive/emissive properties of the matrix material in the IR wavelength range allows for it to emit spacecraft thermal heat loads (e.g., heat from the spacecraft), for example. Herein, emissivity is considered to be the inverse of absorptivity. A secondary phase that is distributed in the first phase may have a characteristic length that is optimized or at least configured to reflect visible light from the Sun away from the thermal spray coating and into space. Herein, emissivity or characteristic length that has been “optimized” indicates that these parameters have a value or range of values that result in achieving one or more specified goals more effectively and efficiently as compared to these parameters having other values. Claimed subject matter is not limited to exact or precise optimization. The secondary phase, which may be voids/defects or high index-lossless material (e.g., diamond), may provide boundary control that causes scattering events.

A two-phase thermal spray may be part of a type of process to coat a substrate with a coating that generally involves two distinct phases: a matrix (e.g., primary) phase and a secondary, or embedded, phase that may comprise particles or voids, as described below. In various implementations, the matrix may not be considered to be a binder, and thus a use or involvement of a salt binder may be avoided. For example, the matrix or primary phase may be a selective surface ceramic. A selective surface ceramic is a type of ceramic material that has favorable thermal radiation properties. For spacecraft applications, selective surface ceramics may provide radiative cooling by optimizing solar reflectance while enhancing thermal emission in the infrared transparency window of space (e.g., 8-13 μm). This allows heat to be effectively radiated away from the spacecraft, helping with temperature regulation in the thermal environment of space. For example, a selective surface ceramic may be selected to reflect most of the solar radiation (e.g., 300 to 2500 nm) to minimize heating from the Sun. This helps to prevent excessive heat buildup on exposed spacecraft surfaces. The ceramic may have relatively strong thermal emissivity in the mid-infrared range. This allows the spacecraft to radiate excess heat into space efficiently without being reabsorbed by the surrounding environment. Selective surface ceramics include yttrium oxide (Y₂O₃), BaF₂, AlN, BaSO₄, and TiO₂ (Rutile/Anatase), just to name a few examples, though claimed subject matter is not limited to these examples or any particular selective surface ceramic.

The matrix phase is the primary material that forms the bulk of the spray coating. As discussed above, it may be a selective surface ceramic material, for example, that is heated and sprayed onto the substrate, which may be a metal such as aluminum, for example. The secondary or embedded phase may be particles that are mixed with (e.g., embedded in) the matrix material before it is sprayed. These particles are a material that is different from the matrix, and they are typically used to enhance certain properties of the coating. For example, the secondary phase may comprise diamonds that contribute to scattering properties of the coating. In some embodiments herein, however, the secondary phase does not comprise particles but instead comprises bubbles or voids in the matrix phase. These bubbles or voids may, in effect, be “defects” that occur in the process of the coating deposition process of the thermal spray on the substrate. Such defects, however, may be intentionally produced by the process and/or parameters of the thermal spray and/or surface preparation of the substrate, for example. In either case, the secondary phase may initiate scattering events through refractive index boundary changes, whether it is diamond at a refractive index of 2.42 or a void at a refractive index of 1.0.

If the secondary phase comprises particles, the matrix and the secondary phase materials may be mixed together and fed into a thermal spray applicator. Inside the applicator the mixture may be heated until the matrix melts. The molten material (with particles mixed therein) may then be sprayed onto the surface (e.g., substrate) that is being coated. As the material hits the surface, the material cools and solidifies, forming a hard, durable coating. The sprayed coating may have a relatively high durability because of the utilization of a thermal spray coating. For example, this material arrangement may be more structurally sound than incumbent cryogenic thermal control coats that utilize ceramic particles in a salt binder. As mentioned above, implementations herein need not involve a salt binder.

If the secondary phase comprises bubbles or voids, the matrix may be fed into a thermal spray applicator and heated until it melts. The molten material may then be sprayed onto the surface (e.g., substrate) in such a way that bubbles or voids (e.g., defects) are formed in the cooled and solidified matrix material. The sprayed coating may have a relatively high durability because of the utilization of a thermal spray coating that includes porosity (e.g., voids).

In some embodiments, a composite material system of a spacecraft comprises i) a substrate configured to radiate heat away from the spacecraft and ii) a thermal spray coating deposited on the substrate. The thermal spray coating may include a primary or first phase and may be a selective surface ceramic. The thermal spray coating may also include a secondary phase that is embedded in the first phase and has a characteristic length (e.g., average diameter of secondary phase elements). For example, an idealized void or particle shape is a sphere that lends to Mie scattering, which tends to optimize scattering since the characteristic length has resonance with (e.g., comparable with the wavelength of) incident solar radiation. The particle diameter of the secondary phase elements may be selected to best represent the solar spectrum and therefore be optimized to reflect it. In some implementations, the characteristic length may include more than one particle diameter. For example, there may be three different particle diameters that each target different portions of the solar spectrum. Mie scattering may relate the particle diameter to the incident solar radiation wavelength that it is optimized to interact with and scatter. In this way, via Mie scattering, visible light from the Sun may be reflected away from the thermal spray coating (and the spacecraft). The optimization may be based on a refractive difference between the first and secondary phases. The optimization may generally relate to a number of things in addition to the refractive index difference between the matrix and secondary phase. For example, other factors that can influence scattering behavior may be magnetically induced particle orientation and particle polarization, particle diameter (for Mie scattering), and concentration of particles/voids. In some implementations, a 30% concentration may be a target value for optimization, though claimed subject matter is not limited in this respect. As described below, the distribution or density of the secondary phase may be based, at least in part, on parameters of a thermal spray applicator that deposited the thermal spray coating on the substrate. As noted above, the secondary phase may be high index, lossless scatterers, such as diamonds, or voids that are lossless low index scatterers. In either case, scattering may be based on differences in refractive indices. Instead of diamonds, other particles may be used in various implementations.

The IR radiation mentioned above may be blackbody radiation having a spectral peak at greater than 6000 nm (nanometers), which may be based on a blackbody temperature of less than about 483 Kelvin (K), which may be an approximate maximum temperature of a spacecraft's thermal radiator, though claimed subject matter is not limited in this respect.

In some embodiments, a method of applying a spray coating on a heat radiator of a spacecraft may include setting input parameters of a thermal spray applicator to form refractive discontinuity elements in a matrix that is applied by the thermal spray applicator. The formation of the refractive discontinuity elements may be based on processes that occur before, after, and/or during the spraying application. The refractive discontinuity elements may have a characteristic length that is optimized or configured to scatter visible light from the Sun, and the matrix may have an emissivity optimized for IR radiation that is based on (e.g., results from) the heat leaving the spacecraft. The method may continue by using the thermal spray applicator to apply the matrix to the heat radiator. Herein, a heat radiator may be any surface or object that radiates heat, such as a particular component or configuration designed to do so. The refractive discontinuity elements may comprise voids such that the refractive index of the voids is substantially 1.0. In other implementations, the refractive discontinuity elements may comprise diamonds (relatively high refractive index of about 2.4). The scattering of the visible light from the Sun may be at least partially Mie scattering by the refractive discontinuity elements. Mie Scattering may optimize the scattering performance of the coating by tailoring the characteristic length of the secondary phase.

In still other embodiments, a composite material system may comprise i) a substrate on a spacecraft configured to radiate heat away from a spacecraft and ii) a matrix that is applied on the substrate by a thermal spray application and that includes refractive discontinuity elements that are formed by the thermal spray application. In the case of voids or defects, the parameters of the thermal spray application may determine, at least in part, characteristic lengths or sizes, density, and/or distribution of the refractive discontinuity elements. For example, such parameters may be powder feed rate, carrier gas flow rates, spray distance, pressure, and/or number of spray passes. The characteristic length or sizes, density, and/or distribution may be selected or optimized to scatter visible light from the Sun.

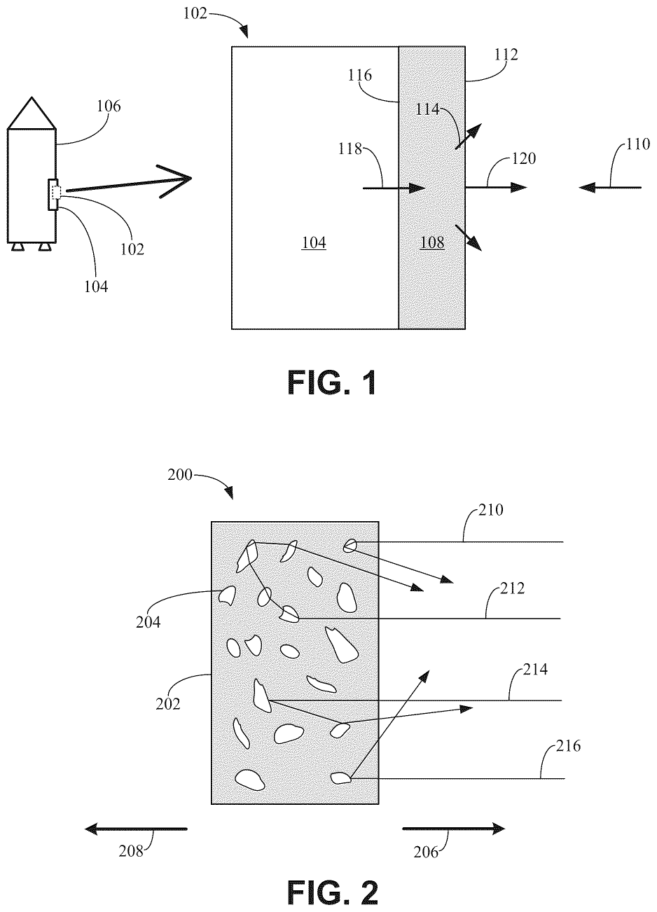

FIG. 1 is schematic diagram of a composite material system 102 that includes a heat radiator 104 of a spacecraft 106, according to some embodiments. The left side of the figure illustrates the radiator disposed on the spacecraft and the right side of the figure illustrates a close-up view of the composite material system. In composite material system 102, the substrate may be radiator 104, which is configured to radiate heat away from the spacecraft. A thermal spray coating, which comprises a matrix 108, such as a selective surface ceramic, may be applied on the substrate by a thermal spray application. Though not illustrated in FIG. 1, matrix 108 may include refractive discontinuity elements that are formed by the thermal spray application.

Heat radiator 104, coated with matrix 108, may be exposed to solar radiation 110, which may partially reflect from outer surface 112 of matrix 108 or transmit into the matrix. This transmitted solar radiation may subsequently be scattered by refractive discontinuity elements in matrix 108. The scattering may result in the transmitted solar radiation ultimately being reflected back out from the matrix, as indicated by arrows 114.

In some implementations, heat from the spacecraft may be collected into heat radiator 104. This heat may then thermally conduct from heat radiator 104 to matrix 108 via interface 116, as indicated by arrow 118. Thermal conduction may continue through the matrix to outer surface 112 where emissivity of the outer surface may play a primary role in how the heat leaves the surface as radiation, as indicated by arrow 120. In other words, at outer surface 112, the heat may be in the form of blackbody radiation, which can be radiated away from the outer surface into space. The capability of outer surface 112 to radiate is based, at least in part, on the emissivity of the outer surface.

FIG. 2 is a schematic view of a thermal spray coating 200, according to some embodiments. Coating 200 may include a matrix 202 and refractive discontinuity elements 204. For example, matrix 202 may be the same as or similar to matrix 108. Arrow 206 indicates a direction toward space and arrow 208 indicates a direction toward a substrate upon which thermal spray coating 200 is applied. For example, the substrate may be part of a heat radiator (e.g., 104) on a spacecraft.

In some implementations, refractive discontinuity elements 204 may be voids, which may, in effect, be bubbles that are formed during the spray application of thermal spray coating 200. In other implementations, refractive discontinuity elements 204 may be high-index particles, such as diamonds, for example. In any case, a difference in the refractive index of matrix 202 and the refractive index of elements 204 is sufficient to redirect (e.g., bend) light rays (e.g., via Snell's Law) and to at least partially reflect light rays at the matrix/element interfaces (e.g., Fresnel's equations and the principle of phase discontinuities). Herein, “light” is not limited to the visible spectrum of electromagnetic radiation (EM) but instead may also include IR, depending on the context in which this term is used.

Several example solar light rays are illustrated to help explain how refractive discontinuity elements 204 in matrix 202 may result in a “net reflection” (e.g., an end-result of multiple reflections of all incoming light) that is in direction 206. A first solar ray 210 enters matrix 202 and encounters one of elements 204. By way of total internal reflection, ray 210 may be redirected, as illustrated. A second solar ray 212 enters matrix 202 and encounters several elements 204. The mismatch between refractive indices of matrix 202 and each of elements 204 results in light “bending”. Accordingly, by way of light bending multiple times and total internal reflection, ray 212 may be redirected, as illustrated. A third solar ray 214 enters matrix 202 and encounters several elements 204. By way of partial reflection of light at surfaces of elements 204, ray 214 may be redirected, as illustrated. A fourth solar ray 216 enters matrix 202 and encounters a single element 204. By way of partial reflection of light at the surface of element 204, ray 216 may be redirected, as illustrated. The other portion (not illustrated) of ray 216, which was not reflected at the interface, may continue into element 204 and internally reflect at the opposite interface of the element and/or continue through the element to scatter from other elements 216.

In some implementations, refractive discontinuity elements 204 may have a characteristic (e.g., average) size that is comparable to the wavelengths of light of solar radiation. Accordingly, Mie scattering may be the primary form of scattering of light by elements 204 in matrix 202. The characteristic size and/or characteristic lengths, density, and/or distribution of elements 204 may be determined or established by various parameters of the thermal spray application from which they are formed (e.g., in the case for voids) or applied (e.g., in the case for diamonds). Moreover, the characteristic size and/or characteristic length of the elements may be optimized to scatter visible light from the Sun. In some implementations, some ways to form voids having the desired characteristic size and/or characteristic length may involve a trial and error (e.g., iterative) process of adjusting thermal spray parameters and assessing results through spectrophotometry and metallographic evaluation. Additionally, matrix 202 may have an emissivity optimized for IR radiation that is based on heat from the spacecraft.

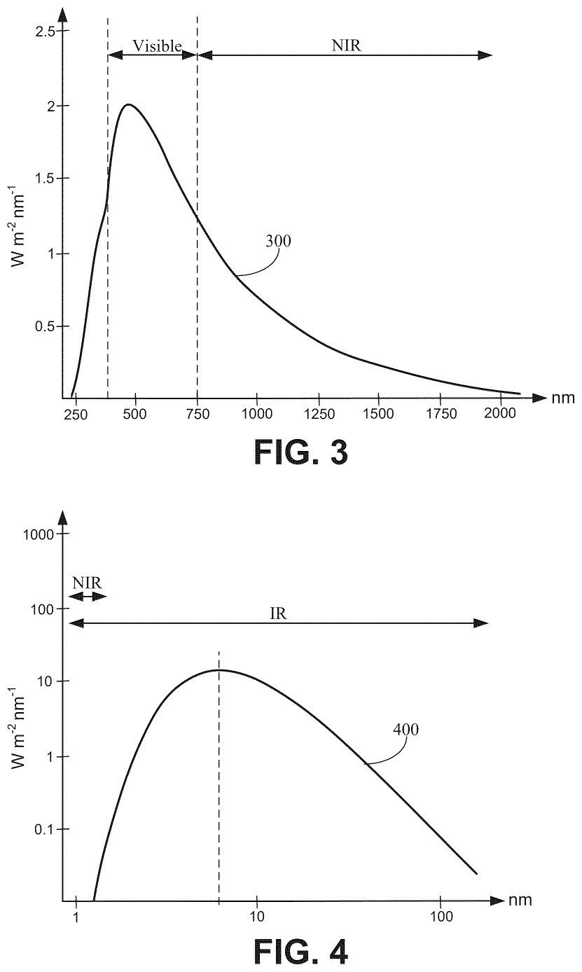

FIG. 3 illustrates a portion of the solar spectrum in space, according to some embodiments. The solar spectrum, as illustrated, represents the distribution of solar radiation outside of Earth's atmosphere. The graph includes designations of the visible and the IR parts of the spectrum. Though the complete solar spectrum covers a wide range of the EM spectrum, from radio waves to gamma rays, the highest intensities are in the visible and near-infrared (NIR) portion of the spectrum, which is illustrated. The Sun's spectrum is approximately that of a blackbody with an effective temperature of about 5800 Kelvin. Accordingly, the Sun's radiation, as seen in space, peaks in the yellow-green part of the visible spectrum. The deviation of the Sun's radiation spectrum from a perfect blackbody radiator is due to the absorption and emission processes occurring in the Sun's atmosphere.

As mentioned above, the characteristic length of refractive discontinuity elements (e.g., 204) in a matrix may be optimized or configured to scatter visible light from the Sun. The integrated area under the visible portion of spectrum curve 300 gives the power density (e.g., power per unit area) that may be involved in such scattering. Depending on the efficacy of the scattering, which may be based on a characteristic size of the scattering particles (e.g., the refractive discontinuity elements) and how they relate to the different wavelengths (e.g., for Mie scattering), a portion of the IR spectrum may also be similarly scattered.

FIG. 4 illustrates a portion of the blackbody spectrum for a heat radiator (e.g., 104) at an example temperature of about 350K, according to some embodiments. In contrast to the solar spectrum illustrated in FIG. 3, because of the substantially cooler temperature of the heat radiator, the blackbody spectrum curve 400 of the radiator is shifted away from the visible and the NIR toward the IR. Accordingly, the emissivity of a matrix (e.g., 202) that coats the heat radiator may have an emissivity optimized for the blackbody spectrum (e.g., IR radiation) illustrated in FIG. 4. This is because heat from the spacecraft, as well as heat from solar radiation that is absorbed and not reflected, may have this or a similar blackbody spectrum.

Thus, in some implementations, the substantial difference between the spectrum of the solar radiation (e.g., curve 300) and the spectrum of the heat (e.g., curve 400) of the radiator, such as at an outer surface of the spacecraft, may allow for optimizing the characteristic length of refractive discontinuity elements to scatter (e.g., reflect) solar radiation (which is mostly visible light) while optimizing the emissivity of the matrix for emitting heat, which is IR radiation, from the spacecraft. In other words, the refractive discontinuity elements and the matrix may perform a “dual function” of emitting EM radiation in one portion of the spectrum while reflecting, via scattering, EM radiation in another portion of the spectrum. Such portions may overlap with each other and claimed subject matter is not limited to any particular spectral range(s).

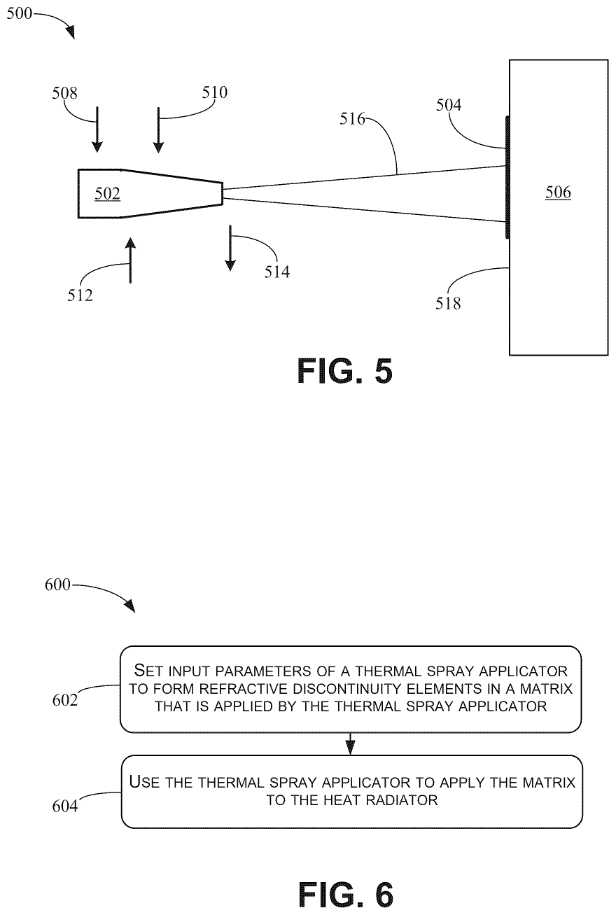

FIG. 5 is schematic diagram of a process 500 of a thermal spray applicator 502 depositing a thermal spray coating 504 on a substrate 506, according to some embodiments. For example, thermal spray coating 504 may be the same as or similar to thermal spray coating 200 and substrate 506 may be the same as or similar to heat radiator 104 of a spacecraft. A number of elements may be provided to applicator 502 such as energy 508, spray material 510 (e.g., a primary and secondary phase), and gas or other process media 512. Each of these elements correspond to parameters that, along with a rate of relative motion 514 of the spraying, may be varied or adjusted to establish or determine, at least in part, a characteristic length and/or size of refractive discontinuity elements that may be formed in process 500. Other such parameters, in addition to those mentioned above, may be that of a spray plume 516 (e.g., divergence angle, concentration, etc.) and/or the texture or material of substrate surface 518, which may be prepared to receive thermal spray coating 504.

Thermal spray applicator 502 may deposit thermal spray coating 504 as, in some implementations, a two-phase thermal spray that includes a matrix phase and a secondary phase which comprises particles. In other implementations, the thermal spray applicator may deposit a thermal spray coating that only includes the matrix. In any case, the matrix phase is the primary material that forms the bulk of the coating. The secondary phase (if included in the process) may be particles that are mixed with the matrix material before it is sprayed. These particles are a material that is different from the matrix, and they are typically used to enhance certain properties of the coating. For example, the secondary phase may comprise diamonds. If the secondary phase comprises particles, the matrix and the secondary phase materials may be mixed together and fed into thermal spray applicator 502. Inside the applicator, the mixture may be heated until at least the primary phase melts. The molten material may then be sprayed onto substrate 506 to be coated. As the material hits the surface, the material cools and solidifies, forming a hard, durable coating.

If the secondary phase comprises bubbles or voids, the matrix may be fed into thermal spray applicator 502 and heated until it melts. The molten material may then be sprayed onto substrate 506 in such a way that voids are formed in the cooled and solidified matrix material.

FIG. 6 is a flow diagram of an example process 600 for applying a spray coating on a heat radiator or other portion of a spacecraft, according to some embodiments. For example, the process may be performed by an operator such as a crew member, an electronic controller, a computer processing system following computer-executable instructions, or a combination thereof.

At 602, the operator may set input parameters of a thermal spray applicator to form refractive discontinuity elements in a matrix that is applied by the thermal spray applicator. The input parameters may be set so that the refractive discontinuity elements have a characteristic length that is optimized to scatter visible light from the Sun. Also, the matrix may have an emissivity that is optimized for IR radiation resulting from heat leaving from the spacecraft. At 604, the operator may use the thermal spray applicator to apply the matrix to the heat radiator.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A composite material system for a spacecraft, comprising:
a substrate configured to radiate heat away from the spacecraft; and
a matrix that is applied on the substrate by a thermal spray application and that includes refractive discontinuity elements that are formed by the thermal spray application, wherein
the refractive discontinuity elements have a characteristic length,
parameters of the thermal spray application determine, at least in part, a distribution of the refractive discontinuity elements,
scattering of visible light from the Sun is based, at least in part, on the characteristic length, and
the matrix has an emissivity having a maximum value for IR radiation of the heat leaving the spacecraft.

2. The system of claim 1, wherein the refractive discontinuity elements comprise voids such that the refractive index of the voids is substantially 1.0.

3. The system of claim 1, wherein the refractive discontinuity elements comprise diamonds.

4. The system of claim 1, wherein the IR radiation is blackbody radiation having a spectral peak at greater than 6000 nm.

5. The system of claim 1, wherein at least a portion of the scattering of the visible light from the Sun is Mie scattering by the refractive discontinuity elements.

6. The system of claim 1, wherein the scattering of the visible light from the Sun comprises a net reflection from the matrix.

7. The system of claim 1, wherein the parameters of the thermal spray application include powder feed rate, carrier gas flow rates, spray distance, pressure, and number of spray passes.

8. The system of claim 1, wherein the matrix is a selective surface ceramic material.

9. A composite material system comprising:
a substrate on a spacecraft configured to radiate heat away from a spacecraft; and
a thermal spray coating deposited on the substrate, wherein the thermal spray coating includes:
a matrix comprising a selective surface ceramic material; and
an embedded phase that is distributed in the matrix and is configured to reflect, via Mie scattering, visible light from the Sun away from the thermal spray coating, wherein the Mie scattering is based, at least in part, on a refractive difference between the matrix and embedded phases.

10. The composite material system of claim 9, wherein the distribution of the embedded phase is based, at least in part, on parameters of a thermal spray applicator that deposited the thermal spray coating on the substrate.

11. The composite material system of claim 9, wherein the embedded phase is voids that have a refractive index of substantially 1.0.

12. The composite material system of claim 9, wherein the embedded phase is diamonds.

13. The composite material system of claim 9, wherein the IR radiation is blackbody radiation having a spectral peak at greater than 6000 nm.

14. The composite material system of claim 9, wherein the parameters of the thermal spray application include powder feed rate, carrier gas flow rates, spray distance, pressure, and number of spray passes.

15. A method of applying a spray coating on a heat radiator of a spacecraft, the method comprising:
setting input parameters of a thermal spray applicator to form refractive discontinuity elements in a matrix that is applied by the thermal spray applicator, wherein the refractive discontinuity elements have a characteristic length that is configured to scatter visible light from the Sun, and the matrix has an emissivity having a maximum value for IR radiation resulting from heat leaving the spacecraft; and
using the thermal spray applicator to apply the matrix to the heat radiator.

16. The method of claim 15, wherein the refractive discontinuity elements comprise voids such that the refractive index of the voids is substantially 1.0.

17. The method of claim 15, wherein the refractive discontinuity elements comprise diamonds.

18. The method of claim 15, wherein the IR radiation is blackbody radiation having a spectral peak at greater than 6000 nm.

19. The method of claim 15, wherein the scattering of the visible light from the Sun is Mie scattering by the refractive discontinuity elements.

20. The method of claim 15, wherein the matrix is a selective surface ceramic material.
